(19) United States
(12) Patent Application Publication
(10) Pub. No.: US 2025/0179254 A1
(43) Pub. Date: Jun. 5, 2025

(54) COMPOSITIONS WITH LITTLE OR NO SOLVENT COMPRISING CARBON NANOTUBES AND AT LEAST ONE POLYMER

(71) Applicant: Arkema France, Colombes (FR)

(72) Inventors: Oleksandr KORZHENKO, LACQ (FR); Christophe VINCENDEAU, LACQ (FR); Patrick DELPRAT, LACQ (FR); Serge BORDERE, LACQ (FR)

(73) Assignee: Arkema France, Colombes (FR)

(21) Appl. No.: 18/862,057

(22) PCT Filed: May 4, 2023
(86) PCT No.: PCT/FR2023/000079

§ 371 Date: Oct. 31, 2024

(30) Foreign Application Priority Data
May 6, 2022 (FR) FR2204308

(51) Int. Cl. C08J 3/12; B29B 9/16; B29K 27/00; C08J 3/205; C08K 3/04; C08K 5/109

(52) U.S. Cl. CPC C08J 3/124; B29B 9/16; C08J 3/205; C08K 3/041; C08K 5/109; B29B 2009/166; B29K 2027/16; B29K 2039/06; C08J 2339/06; C08J 2427/16

(57) ABSTRACT

The present invention relates to compositions of carbon nanotubes which can be used in solid form, that is to say in the absence of solvent. These compositions comprise at least one polymer and are readily dispersible in formulations for the manufacture of electrodes for batteries and in particular Li-ion batteries in liquid or solid processes. The invention also relates to the process for obtaining these powders, to their use in the manufacture of electrodes for batteries, and also to the batteries comprising them.

### FIELD OF THE INVENTION

The present invention relates to compositions comprising carbon nanotubes in powder form. These compositions in powder form comprise at least one polymer and are readily dispersible in solvent-comprising or solvent-free formulations for the manufacture of electrodes for batteries and in particular Li-ion batteries.

### CONTEXT

Carbon nanotubes are made of rolled-up sheets of graphite. The nanotubes can be composed of a single sheet and are then known as single-walled nanotubes (SWNTs). The nanotubes can also be composed of several concentric sheets and are then known as multi-walled nanotubes (MWNTs). Consequently, carbon nanotubes are ideal candidates for a vast range of applications, in particular as additives for improving the electronic resistance of materials and devices such as battery electrodes, including anodes and cathodes, especially in lithium-ion batteries. These improvements in battery performance form part of the development of electric vehicles and therefore the fight against global warming.

Carbon nanotubes such as can be obtained in known synthesis processes cannot be directly formulated with the components used in the composition of the battery electrodes because they come in the form of entangled bundles or balls. Their relative density is too low, typically less than 0.1, and the formulations obtained do not exhibit the improvements in electrical conduction that might be expected due to their presence.

Nowadays, their use requires prior dispersion in a liquid form comprising a solvent which can be water or an organic solvent. This dispersion in a liquid makes it possible to release the carbon nanotubes from their entanglements, but requires large amounts of solvent. Given the small amounts of carbon nanotubes present in these dispersions, it is consequently necessary to transport large amounts of material between the sites of production of carbon nanotubes and the dispersion thereof and the sites of manufacture of electrodes and batteries using these dispersions, entailing a very unfavorable carbon footprint.

Solutions are therefore sought which minimize the amounts of solvent required for the manufacture of these dispersions, or even which eliminate the solvent. Transporting the carbon nanotubes combined with other compounds in dry form with a high content of carbon nanotubes is an alternative that has the best carbon footprint. To date, EP2550699 describes compositions comprising carbon nanotubes combined with a solvent and with a polymer that aids the dispersion of the carbon nanotubes. This document describes the manufacture of carbon nanotubes/water/carboxymethylcellulose pellets. These pellets can then be dried in an oven and be redispersed before the formulation of electrodes.

However, these pellets do not make it possible, during the manufacture of an electrode, to achieve an electrical performance equivalent to that obtained with a dispersion in a solvent obtained by ball milling for example, which constitutes the method currently used industrially. Consequently, there is to date no solution enabling the formulation of electrodes comprising carbon nanotubes under optimal conditions. Either the dry route of EP2550699 does not allow optimal electrical performance qualities, or the route in the presence of a solvent requires the transportation of large amounts of carbon nanotubes formulated in the presence of solvent.

The applicant has consequently sought a dry form other than pellets, this dry form being able to be redispersed by the user during the electrode preparation step. In this way, the volumes of materials transported are considerably reduced.

Unexpectedly, the applicant has discovered that, with certain parameters of density and porosity of a powder, it is possible to obtain a carbon nanotubes-polymer composition which can be redispersed very well and which affords performance qualities equivalent to the liquid route. These powder-form carbon nanotubes-polymer compositions can then be correctly reformulated in a high-performance electrode for batteries. In particular, these powders may be combined with the other components of the electrodes either by returning to a solvent route for manufacturing the electrode, by depositing the mixture in liquid form and then drying the electrode, or by depositing these powders together with the electrode components mixed in solid form and then deposited by a suitable method such as electrostatic spraying followed by calendering.

### SUMMARY OF THE INVENTION

The invention relates to a composition comprising carbon nanotubes and at least one polymer, in a carbon nanotube/polymer mass ratio of less than 100/5, said composition being in the form of a powder of loose bulk density of between 0.11 and 0.5 g/cm³, having an apparent specific surface area of between 50 and 350 m²/g and a content of solvent of less than 10% by mass.

### DETAILED DESCRIPTION

The compositions of the invention have a carbon nanotube/polymer mass ratio of less than 100/5, preferably of less than 10/1, preferably of less than 4/1, but greater than 1/1.

The compositions of the invention are in the form of a powder of spheroidal grains the diameter of which varies from a few microns to around a hundred microns.

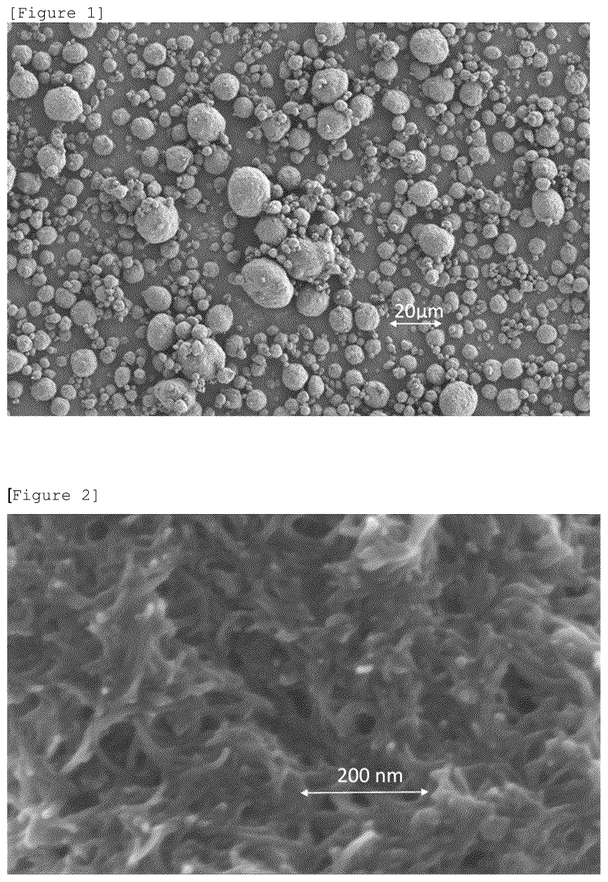

FIG. 1 shows a scanning micrograph of a typical powder of the invention.

FIG. 2 shows the morphology at the surface of a grain of a typical powder of the invention.

These powders comprising carbon nanotubes may be obtained under certain conditions of drying a dispersion, of which atomization (spray drying) is one possibility exemplified by the applicant.

These dispersions are manufactured from carbon nanotubes generally of a relative density of less than 0.1 treated under high shear in the presence of a solvent and at least one polymer. During the preparation of these dispersions, other compounds may be combined with these dispersions.

Among the other compounds which may be added to the compositions of the invention, mention may be made of carbon fibers, carbon nanofibers, graphene, or also carbon black. Preference is given to carbon black. When carbon black is involved, the carbon nanotubes/carbon black mass ratios may range from 100/1 to 1/100, preferably from 100/5 to 1/5.

The carbon nanotubes present in the compositions of the invention may be single-walled or multi-walled carbon nanotubes. They are preferably multiwalled. They are in entangled form or in bundle form. They are preferably in entangled form. They may be purified, that is to say freed of residual impurities present at the end of their synthesis, in particular metals.

The polymers used within the context of the invention may be homopolymers, random copolymers, block copolymers or also gradient copolymers, it being possible for these various polymers to be combined or used alone. Preferably, the polymers have a weight-average molecular mass of less than 150 000 g/mol, preferably of less than 120 000 g/mol and more preferably of less than 80 000 g/mol, measured by size exclusion chromatography calibrated with polystyrene standards.

The choice of the polymer or of the combination of several polymers is adapted to the solvent used for preparing the preliminary dispersions comprising the carbon nanotubes. The polymers must be soluble in the solvent, that is to say exhibit a homogeneous solution.

“Soluble” is understood to mean the possibility of dissolving at least 5 g of polymer per liter of solvent and preferably at least 20 g per liter of solvent at a temperature of between 5 and 80° C., preferably between 15 and 35° C. and more preferably between 15 and 25° C.

Thus, any type of polymer and any type of solvent may be suitable within the context of the invention, provided that the polymer-solvent pair satisfies the condition of solubility.

The solvents are chosen in nonlimiting fashion from water, N-methylpyrrolidone, triethyl phosphate, Cyrene™, dimethyl sulfoxide, dimethylformamide, ketones, acetates, furans, alkylcarbonates, alcohols, and mixtures thereof. The solvent may be CO₂ in the supercritical state. The solvent is preferably water.

The polymer may be a copolymer comprising (meth)acrylic or styrenic monomeric entities, of which at least one entity has a functionality chosen from hydroxy, acid, sulfonic acid, epoxy, amide, ether, ester and pyrrolidone. Among these functional or non-functional monomers, mention may be made of monomers such as methacrylic acid, acrylic acid, dimethylacrylamide, glycidyl methacrylate, hydroxyethyl acrylate, methyl methacrylate, methyl acrylate and more generally substituted or unsubstituted, cyclic or noncyclic alkyl (meth)acrylates, but also substituted or unsubstituted styrenes, 2-acrylamido-2-methylpropanesulfonic acid, and N-vinylpyrrolidone. The polymer may also be chosen from polysaccharides, modified polysaccharides, polyacrylamide homopolymers or copolymers, polyacrylic acid homopolymers or copolymers comprising predominantly acrylic acid, polyvinyl alcohol homopolymers or copolymers, polyvinylpyrrolidone homopolymers or copolymers, and also mixtures of these polymers.

Preferably, the polymers used are chosen from carboxymethylcelluloses, polyvinylpyrrolidone homopolymers or copolymers, polyvinyl alcohol homopolymers or copolymers, polyacrylic acid homopolymers or copolymers comprising predominantly acrylic acid, and more particularly carboxymethylcelluloses (CMCs), polyvinylpyrrolidone homopolymers or copolymers and more preferably polyvinylpyrrolidone homopolymers or copolymers. As regards the polyvinylpyrrolidone homopolymers or copolymers, the weight-average molecular mass is between 10 000 and 120 000 g/mol, preferably between 20 000 and 60 000 g/mol and more preferably between 20 000 and 40 000 g/mol. The polymers having acid functional groups (CMC, polyacrylic acids, etc.) may be used in the form of their alkali metal salts, preferably Li⁺ or Na⁺).

Moreover, halogenated polymers such as PVDF or nonhalogenated elastomers in combination or otherwise may be jointly present in addition to the polymers already present. These are polymers used in the composition of the electrodes and which can be added at this stage, i.e. before the final formulation of the electrode.

The invention also relates to these compositions in the presence of halogenated polymers such as PVDF or nonhalogenated elastomers, alone or in combination.

The term “PVDF” employed here includes vinylidene fluoride (VDF) homopolymers or copolymers of VDF and of at least one other comonomer in which the VDF represents at least 50 mol %. The comonomers which can be polymerized with VDF are chosen from vinyl fluoride, trifluoroethylene, chlorotrifluoroethylene (CTFE), 1,2-difluoroethylene, tetrafluoroethylene (TFE), hexafluoropropylene (HFP), perfluoro(alkyl vinyl) ethers, such as perfluoro(methyl vinyl) ether (PMVE), perfluoro(ethyl vinyl) ether (PEVE) or perfluoro(propyl vinyl) ether (PPVE), perfluoro(1,3-dioxazole), perfluoro(2,2-dimethyl-1,3-dioxozole) (PDD), the product of formula CF₂═CFOCF₂CF(CF₃)OCF₂CF₂X in which X is SO₂F, CO₂H, CH₂OH, CH₂OCN or CH₂OPO₃H, the product of formula CF₂═CFOCF₂CF₂SO₂F, the product of formula F(CF₂)ₙCH₂OCF═CF₂ in which n is 1, 2, 3, 4 or 5, the product of formula R1CH₂OCF═CF₂ in which R1 is hydrogen or F(CF₂)_{z} and z has the value 1, 2, 3 or 4, the product of formula R3OCF═CH₂ in which R3 is F(CF₂)_{z} and z has the value 1, 2, 3 or 4, or also perfluorobutylethylene (PFBE), fluorinated ethylene propylene (FEP), 3,3,3-trifluoropropene, 2-trifluoromethyl-3,3,3-trifluoro-1-propene, 2,3,3,3-tetrafluoropropene or HFO-1234yf, E-1,3,3,3-tetrafluoropropene or HFO-1234zeE, Z-1,3,3,3-tetrafluoropropene or HFO-1234zeZ, 1,1,2,3-tetrafluoropropene or HFO-1234yc, 1,2,3,3-tetrafluoropropene or HFO-1234ye, 1,1,3,3-tetrafluoropropene or HFO-1234zc, and chlorotetrafluoropropene or HCFO-1224. The PVDF may be introduced into the compositions of the invention in dissolved form or in the form of a latex in the particular case in which the process for preparing the compositions of the invention in powder form is atomization.

The nonhalogenated elastomers may be of the type of natural or non-natural rubbers, nitrile rubbers, NBRs (nitrile-butadiene rubbers), SBRs (styrene-butadiene rubbers), substituted polyphosphazenes, acrylic polymers or silicone polymers, optionally in a combination of these elastomers. According to one variant of the invention, the compositions of the invention may also be supplemented with additives and in particular organic carbonates such as ethyl carbonate, propyl carbonate, diethyl carbonate, dimethyl carbonate and fluoroethylene carbonate, alone or as a mixture, and preferably ethyl carbonate with a proportion of the organic carbonate of less than 60% by mass relative to the polymer and optionally moisture absorbers such as lithium bis(trifluoromethane)sulfonimide, lithium hexafluorophosphate, lithium tetrafluoroborate, lithium bis(fluorosulfonyl)imide, lithium perchlorate, lithium hexafluoroarsenate, and 4,5-dicyano-2-(trifluoromethyl)imidazole in acid or lithium salt form, alone or as a mixture, and in particular 4,5-dicyano-2-(trifluoromethyl)imidazole in acid or lithium salt form, in a maximum amount of 50% by mass relative to the carbon nanotubes.

The invention also relates to these compositions in the presence of these additives.

The compositions of the invention in powder form may be prepared by various processes, among which mention may be made of the process of precipitating the compositions comprising carbon nanotubes/solvent/polymer with the aid of a nonsolvent of the polymer, the process of freeze-drying the compositions comprising carbon nanotubes/solvent/polymer, the process comprising the steps of extrusion of the compositions comprising carbon nanotubes/polymer with injection of supercritical CO₂ during the extrusion step with a proportion by mass of supercritical CO₂ of between 25% and 1000% of the composition followed by degassing of the CO₂, or another device employing supercritical CO₂, or the process of atomizing the compositions comprising carbon nanotubes/solvent/polymer.

During the preparation the compositions of the invention in powder form with one or other of the processes, the additives may be added together to the compositions comprising carbon nanotubes and at least one polymer. Powders are then obtained which may comprise carbon nanotubes, at least one polymer and one or more additives.

According to a preferred embodiment, the compositions in powder form are prepared by the process comprising the steps of extrusion of one of these compositions comprising carbon nanotubes and at least one polymer with injection of supercritical CO₂ during the extrusion step with a proportion by mass of supercritical CO₂ of between 25% and 1000% of the composition comprising carbon nanotubes and at least one polymer followed by degassing of the CO₂ and recovery of powder.

Thus, the present invention also relates to a process for obtaining compositions of the invention by extrusion of the compositions comprising carbon nanotubes and at least one polymer, with injection of supercritical CO₂ during the extrusion step, with a proportion by mass of supercritical CO₂ of between 25% and 1000% of the composition followed by degassing of the CO₂ and recovery of powder.

According to a yet more preferred embodiment, the compositions in powder form are prepared by the atomization process.

In the case of atomization, the process is as follows:

The compositions of the invention are prepared in two steps:

A first step consists in dispersing the carbon nanotubes in the presence of at least one polymer and of the solvent in a suitable device chosen from deflocculators, ball mills, z-dispersion devices equipped with rotor/stator stirring, ultrasound or also cavitators. These are devices making it possible, under high shear, to dissociate the balls of carbon nanotubes and to correctly disperse them in the solvent. Preference is given to deflocculators and ball mills in combination or otherwise.

During this step, it is also possible to combine the PVDF and/or the nonhalogenated elastomers and/or the additional compounds such as the organic carbonates or the moisture absorbers.

The process is carried out in carbon nanotubes-polymer proportions by mass of between 3% and 20% and preferably between 5% and 10% relative to the solvent. The dispersion thus obtained is then diluted in the solvent so that its viscosity is brought to Brookfield values of between 50 and 10 000 centipoise and preferably between 100 and 1500 centipoise. The viscosity values relate to the dispersions measured at the end of their preparation. The viscosity of these dispersions may change slightly over time beyond 10 000 centipoise. In the interests of good stability, it is advisable to operate under conditions of pH of the dispersion of between 3 and 12 and preferably between 5 and 10.

In a second step, the latter dispersion is atomized by passing into a gas stream which may be air, an inert gas or a mixture of inert gases, or else air and inert gas, with a temperature of gas entering the atomizer of greater than 120° C., preferably of between 12° and 240° C. and more preferably between 14° and 240° C., ideally between 20° and 240° C., and the carbon nanotube/polymer powder is recovered. Drying post-atomization may prove to be necessary in order to bring the solvent content down to less than 0.5% by mass. Alternatively, and depending on the formulations used during the subsequent electrode manufacturing process, PVDF and/or the nonhalogenated elastomers in the form of a latex may be added to the compositions of the invention during the atomization phase.

Thus, the present invention also relates to a process for obtaining the compositions of the invention by atomization, comprising the following steps:
dispersing carbon nanotubes in a solvent in the presence of at least one polymer,
atomizing the dispersion with a gas heated to a temperature of greater than 120° C. and then recovering powder.

Preferably, the solvent used in the atomization process is water.

The compositions of the invention are in the form of powders of porous unit particles or aggregates of porous unit particles, preferably with a particle size corresponding to Dᵥ10 values of between 4 and 8 μm, Dᵥ50 values of between 15 and 30 μm and Dᵥ90 values of between 50 and 100 μm, Dᵥ denoting the volume-average diameter. The measurement is carried out using a Malvern-type laser diffraction apparatus (Mastersizer 3000). Powders having larger or smaller particle sizes would not constitute a departure from the scope of the invention.

The powder has an apparent specific surface area of between 50 and 350 m²/g and preferably between 90 and 200 m²/g. The BET measurement is carried out using an ASAP 2460 apparatus from Micromeritics.

The powder has a loose bulk density of between 0.11 and 0.5 g/cm³, with preference between 0.12 and 0.5 g/cm³, and preferably between 0.15 and 0.5 g/cm³.

The powder has a content by mass of residual solvent of less than 10%, with preference less than 6% and preferably less than 5%.

The powder-form compositions of the invention are useful for the manufacture of battery electrodes and in particular for the manufacture of cathodes. To manufacture the electrodes, the compositions of the invention are mixed either in a form dispersed in a solvent with the other compounds of the electrode, or as-is with the other compounds of the electrode, that is to say in dry form in a suitable mixer.

During the manufacture of the electrode formulations with the compositions of the invention, the mixing will preferably be carried out with an extruder. This is because the applicant has found that the extruder is the device that gives the best electrical conductivity results in the formulations used for electrodes.

The invention therefore also relates to electrodes manufactured using these powders and preferably cathodes.

According to a first preference, the powders of the invention are thus mixed with an active material of lithium NMC (nickel manganese cobalt) oxide, LFP (lithium iron phosphate), LMO (lithium manganese oxide) or LMNO (lithium manganese nickel oxide) type and a fluoropolymer that is typically PVDF and/or nonhalogenated elastomers if these are not already present in the compositions of the invention, in a suitable mixer, for example a disk mixer or a planetary mixer, and then a solvent is added. The mixture obtained is deposited on a conductive plate and then the solvent is evaporated off.

According to a second preference, this constituting another advantage of the invention, it is possible to use the powders of the invention in solvent-free electrode formulation processes (known as “dry processes”), that is to say the direct formulation of the powders of the invention with powders of active material of the electrode and other compounds depending on whether the electrode is an anode or a cathode. Thus, all of the ingredients constituting an electrode can be directly mixed in powder form, without solvent, and the electrode can be shaped by hot lamination/calendering, electrospray (electrostatic powder deposition) followed by hot lamination.

Other solvent-free technologies can therefore advantageously use the compositions of the invention in powder form, in the extrusion of the active materials of cathodes or anodes formulated directly in the liquid or solid electrolyte and thus manufacture cathodes or anodes directly usable in the assembly of batteries.

The invention also relates to the use of the compositions of the invention for obtaining electrodes, cathodes or anodes, to the electrodes, cathodes or anodes obtained using the compositions of the invention formulated by the solvent route or in dry form and preferably cathodes, and also to the batteries obtained with these electrodes.

### EXAMPLES

The examples were performed with Graphistrength® C100 carbon nanotubes (Arkema) having residual metal contents of less than 50 ppm.

### Example 1: Reference Carbon Nanotube Liquid Composition. Comparative, Outside the Invention

In this example, a carbon nanotube composition typical of the practices used in the industry to date is reproduced. The composition comprising carbon nanotubes is therefore a liquid composition with a low content of carbon nanotubes and a high content of solvent. This composition is used in example 2 for the manufacture of a reference electrode constituting the objective to be achieved with the compositions of the invention.

100 g of carbon nanotubes, 25 g of PVP (polyvinylpyrrolidone) (weight-average molecular mass of 24 000 g/mol) and 1000 g of N-methylpyrrolidone are introduced into a deflocculator. This mixture is homogenized in a deflocculator and then processed in a horizontal ball mill so as to disperse the particles of carbon nanotubes. The balls used have a diameter of 0.6 mm in diameter and the duration of milling is 200-260 minutes. Additional N-methylpyrrolidone (166 g) is added so as to obtain a fluid and handleable composition.

The viscosity of the dispersion denoted Dref obtained is measured on a Brookfield viscometer. The composition obtained Dref has a content of carbon nanotubes of 7.68% and the viscosity is measured as 600 centipoise at 25° C.

### Example 2: Manufacture of a Reference Electrode (Cathode)

The dispersion Dref obtained in example 1 is introduced into a planetary mixer, followed by the addition of 95 g of lithium nickel manganese cobalt oxide containing an Ni:Mg:Co ratio of 6:2:2, referred to as NMC 622, N-methylpyrrolidone comprising PVDF (sold by Arkema under the reference Kynar HSV 1810), for 30 minutes, so as to obtain a paste with all of the constituent compounds of a cathode. The formulation obtained, expressed in dry form, is as follows, in percentage by mass:
97.75% NMC 622;
1% carbon nanotubes;
1% PVDF;
0.25% PVP.

The solids content is 74%.

The electrode is prepared by coating using a Sheen film applicator and an adjustable BYK-Gardner applicator. A 200 μm thick film is applied to a 25 μm thick aluminum foil on a polyethylene terephthalate (PET) sheet constituting an insulating support. Drying in a ventilated oven is carried out at 120° C. for 2 h.

The dried electrode is then calendered to achieve a final film thickness of around 80 μm.

In order to calculate the resistivity, the electrode supported by the PET is cut out into a 3×4 cm format. Silver lacquer is painted at the ends of the cutout. Once the lacquer has dried, the resistivity (R) is measured at 25° C. with an ohmmeter.

The value of the resistivity R is a good indication of the performance of the effect of the carbon-based additive (carbon nanotubes in the present case). A resistance of 7 ohms is measured on this electrode. This value constitutes the reference and therefore the objective to be achieved within the context of the invention.

### Example 3: Dry-Form Composition of Carbon Nanotubes According to the Known Prior Art. Comparative 2, Outside the Invention

This example is carried out in accordance with EP 2550699.

4 kg of carbon nanotubes are mixed with 200 g of PVP (weight-average molecular mass of 24 000 g/mol). After adding 14 L of demineralized water, the mixture is homogenized in a 60 L rotary mixer.

The mixture is then introduced into the hopper of a Clextral BC21 extruder by a gravimetric metering device set at 15 kg/h followed by a suitable pelletization of the strand obtained. The temperature control system of the extruder is set at 50° C. The rotational speed of the screws is 400 rpm. Cylindrical pellets with a diameter of 4-5 mm and a length of between 3-20 mm are obtained.

The pellets are then dried in a ventilated oven at 140° C. for 4 h.

The bulk density of the pellets is 1.2 g/cm³. These pellets are milled in a gas jet mill to obtain a powder having a Dᵥ90<100 μm. The loose bulk density of this powder after milling was measured as 0.85 g/cm³. This powder obtained is denoted P0 and has an apparent specific surface area measured by BET of 34 m²/g. The BET measurement is carried out using an ASAP 2460 apparatus from Micromeritics.

The loose bulk density (LBD) is defined by the ratio of the mass of powder to its volume after having been loosened.

The measurement is carried out by measuring the maximum volume occupied by the powder in a 100 cm³ closed graduated cylinder of mass T turned over several times slowly. The weighings are performed using a balance accurate to 0.1 g.

The cylinder is filled to three-quarters and then weighed to give a mass m1, closed, and then slowly turned over several times until the maximum volume occupied by the powder is obtained. The volume occupied is denoted v in cm³. The loose bulk density expressed in g/cm³ is calculated by the following formula:

$$LBD = ( m 1 - T ) / v$$

### Example 4: Composition of Carbon Nanotubes and PVP According to the Invention

The composition described in example 1 is produced in an identical manner but the N-methylpyrrolidone is replaced with water.

The solids composition is as follows: 100 g of carbon nanotubes and 25 g of poly(vinylpyrrolidone) (PVP) with a carbon nanotubes/PVP mass ratio of 4/1. This mixture is homogenized in a deflocculator with 1000 g of water, and then milled in a horizontal ball mill as described in example 1. The additional amounts of water were added during the milling in order to adjust the viscosity. At the end of milling, the solids content is 6% by mass and the proportion of carbon nanotubes is 4.8%. The final viscosity is 500 centipoise.

The aqueous dispersion is then dried in an atomizer. The dispersion is sprayed in the presence of a stream of air preheated to various temperatures.

The solid compositions P1 to P4 are collected in powder form at the outlet of the atomizer under the conditions given in table 1.

TABLE 1

| | T | LBD | H | S | G |
|---|---|---|---|---|---|
| P1 | 120 | 0.38 | 6 | 34 | |
| P2 | 160 | 0.32 | 3.84 | 92 | 6/19/63 |
| P3 | 200 | 0.31 | 4.95 | 117 | 7/24/88 |
| P4 | 240 | 0.28 | 1.95 | 158 | 6/19/65 |

T: Temperature of the preheated air entering the atomizer ° C.
LBD: Loose bulk density.
H: % by mass of residual moisture.
S: Apparent specific surface area, BET m²/g.
G: Particle size distribution Dᵥ10/Dᵥ50/Dᵥ90 in μm.

The 4 powder samples P1 to P4 obtained on conclusion of the atomization are then treated in a vacuum oven to remove the residual moisture.

The formulations of this example in the form of powders are used directly in the formulation of an electrode of NMC cathode type, as described in example 2.

All of the formulations obtained in this example have a much lower bulk density compared to the solid milled aggregates of example 3 (P0). P2, P3 and P4 have apparent specific surface areas greater than P0 and P1.

### Example 5: Production of Cathode Inks and Evaluation of Cathodes with the Carbon Nanotube Powders P1 to P4 and Sample P0 of Example 3

Two methods are used to make the cathode of the formulation described in example 2.

Method 1: The formulation is identical to the method of example 2, but with the use of the powders P0 to P4 instead of the dispersion Dref of example 1. NMC 622, PVDF Kynar HSV8010 and the powders P0 to P4 were dry premixed in a planetary mixer and then in a disk mixer at 50° C. for 40 min. N-methylpyrrolidone was added gradually to maintain the viscosity of the cathode inks obtained within the values of 6000-10 000 centipoise.

Method 2: With this method, the cathode paste is manufactured according to the original extrusion method from the milled pellet dry products P0, P1 to P4 powders obtained by atomization and also the active materials and the PVDF binder. In this case the liquid Dref cannot be used. The NMC 622 and PVDF Kynar HSV8010 mixture is extruded successively with the powders P0 to P4 using a micro-extruder sold by the company DSM. NMP and then the powders P are introduced together with the NMC 622 and PVDF Kynar HSV8010 mixture. The NMP is added to the solid mixture and adjusted so as to obtain viscosities of the inks obtained of between 6000 and 10 000 centipoise and are used to produce the electrodes as described in example 2.

The following identical steps are followed for the powders P0 to P4:
Introduction of 9.35 mL of NMP into the extruder, preheated to 50° C.; once the NMP has been introduced, the screw speed is increased to 240 rpm;
42.6 g of the powders P together with the NMC 622 and PVDF Kynar HSV8010 mixture are gradually introduced over 30-60 seconds; the torque is continually monitored; it is adjusted with NMP so as to remain in the range 1000-1400 N·m.
once the torque has stabilized, 4.9 g of NMP are gradually introduced over 30-60 seconds; the torque gradually drops to 100 N·m.
The cathode ink is recovered at the extruder outlet. The solids content is 76-78%. 5 cathode inks are obtained with the 5 powders P0, P1, P2, P3 and P4 used to produce the electrodes as described in example 2.

The cathodes produced as described in example 2 from the inks obtained by the two methods have similar thicknesses, of the order of 78-82 μm, and their resistances are given in table 2. The value of the reference cathode produced according to the conventional method from a liquid dispersion can be seen.

TABLE 2

| | Example 2 | Example 4 | Example 4 |
|---|---|---|---|
| | Reference | Method 1 | Method 2 |
| | Resistivity | Resistivity | Resistivity |
| Source of carbon | Cathode | Cathode | Cathode |
| nanotubes | Ohms cm | Ohms cm | Ohms cm |
| P0 | | 55 ± 5 | 18 ± 2 |
| P1 | | 12 ± 1 | 8 ± 1 |
| P2 | | 8 ± 1 | 7 ± 1 |
| P3 | | 9 ± 1 | 7 ± 1 |
| P4 | | 9 ± 1 | 7 ± 1 |
| Dref | 7 ± 1 | | |

These results show that the cathodes obtained from the compositions of the invention display an electrical performance superior to those of the prior art such as the powders obtained from the pellets of EP 2550699 (P0), but give the same results in terms of electrical performance as the carbon nanotube dispersion based on NMP of example 1 (Dref). The particles of lower relative density, resulting from atomization at an air stream temperature of greater than 120° C., display results close to the reference. It can therefore be concluded that carbon nanotubes usable in such applications must have relative densities of less than 0.5.

The extrusion method (method 2) gives the results closest to the reference of example 2. The use of the powders P0 obtained from the pellets of EP 2550699 gives results which always remain shifted with respect to the products of the invention.

### Example 6: Measurement of the Absorbance

The dry powders (P0 and P4) were introduced into NMP at 6% by mass at ambient temperature.

After mixing at 600 rpm with a disk mixer for 30 min, the precise solids content was evaluated with a thermobalance. Solutions with dilutions to 50+−2 ppm were prepared.

The absorbance is measured using a HACH DR1900 spectrophotometer at a light wavelength of 360 nm.

The absorbance (A), also called optical density (OD), is the amount of light absorbed by a dispersion. The greater the absorbance A, the better the particles are distributed in the dispersion volume (table 3).

TABLE 3

| | Absorbance A |
|---|---|
| Dispersion of example 1 Dref | 3.2-3.4 |
| Dispersion with P0 | 2.2-2.6 |
| Dispersion with P4 | 3-3.4 |

The dispersion produced from the powder P4 of the invention has an absorbance equivalent to that of example 1 Dref, much higher than that obtained from P0, demonstrating a good distribution of the carbon nanotubes obtained from P4 in the solvent.

### Example 7

This example evaluates the synergy of the combination of carbon black with carbon nanotubes in the electrodes manufactured using the compositions of the invention compared to those of the compositions of the prior art (solvent-type route of example 1, route using the pellets obtained from EP 2550699 P0 and dry by mixing P2 with carbon black).

The combination with carbon black during the atomization step gives the best results. (Table 5)

The electrodes are formulated according to a recipe in the proportions of the components in table 4:

TABLE 4

| | % by mass |
|---|---|
| Active filler NMC622 (UMICORE) | 96.38 |
| Carbon Black C65 (Imerys) | 1.5 |
| Carbon nanotubes | 0.5 |
| PVDF Kynar ® 1810 (Arkema) | 1.5 |
| PVP K25 (Aldrich) | 0.12 |

Table 5 shows the resistances measured on cathodes produced from 4 ways of mixing carbon nanotubes and carbon black. The mixing carried out prior to atomization according to the compositions of the invention has the best characteristics once formulated as an electrode. The carbon nanotubes/carbon black synergy is at its maximum using the procedure and compositions of the invention.

TABLE 5

| | Resistivity Ohms cm |
|---|---|
| | Cathode solvent route |
| Dry mixing with P2 | 15 ± 1 |
| Mixing in the dispersion of example 1 | 13 ± 1 |
| Mixing before atomization according to the | 10 ± 1 |
| invention | |
| Dry mixing with powder P0 | 21 ± 1 |

1. A composition comprising carbon nanotubes and at least one polymer, in a carbon nanotubes/polymer mass ratio of less than 100/5, said composition being in the form of a powder of loose bulk density of between 0.11 and 0.5 g/cm³, having an apparent specific surface area of between 50 and 350 m²/g measured with the aid of a Micromeritics ASAP 2460 instrument and a content by mass of solvent of less than 10%, wherein the polymer is chosen from modified polysaccharides, polyvinylpyrrolidone homopolymers or copolymers, the loose bulk density (LBD) being defined by the ratio of the mass of powder and its volume after having been loosened, the measurement being performed by measuring the maximum volume occupied by the powder in a 100 cm³ closed graduated cylinder of mass T turned over several times slowly with weighings performed using a balance accurate to 0.1 g and filling the cylinder to three-quarters and then weighed to give a mass m¹, closed, and then slowly turned over several times until the maximum volume occupied by the powder, denoted v, in cm³, is obtained, resulting in an loose bulk density expressed in g/cm³ and calculated by the following formula LBD=(m¹−T)/v.

2. The composition as claimed in claim 1, wherein the polymer is chosen from polyvinylpyrrolidone homopolymers or copolymers having a molecular mass of between 20,000 and 60,000 g/mol.

3. The composition as claimed in claim 1, further comprising carbon black in carbon nanotubes/carbon black mass ratios ranging from 100/1 to 1/100.

4. The composition as claimed in claim 1, further comprising at least one organic carbonate such as ethyl carbonate, propyl carbonate, diethyl carbonate, dimethyl carbonate and fluoroethylene carbonate, alone or as a mixture.

5. The compositions as claimed in claim 1, further comprising at least one compound chosen from lithium bis(trifluoromethane)sulfonimide, lithium hexafluorophosphate, lithium tetrafluoroborate, lithium bis(fluorosulfonyl)imide, lithium perchlorate, lithium hexafluoroarsenate, and 4,5-dicyano-2-(trifluoromethyl)imidazole in acid or lithium salt form, alone or as a mixture, and in particular 4,5-dicyano-2-(trifluoromethyl)imidazole in acid or lithium salt form.

6. The composition as claimed in claim 1, further comprising PVDF, homopolymer or copolymer and/or a non-halogenated elastomer.

7. A process for preparing a composition as claimed in claim 1, using an atomizer and comprising the following steps:
preparing a composition as claimed in claim 1, in the presence of a solvent in a deflocculator, at a temperature of between 5 and 80° C., in order to obtain a dispersion comprising carbon nanotubes,
atomizing the dispersion with a gas heated to a temperature of greater than 120° C. and recovering the powder.

8. A process for preparing a composition as claimed in claim 1, comprising the steps of extrusion of the composition with injection of supercritical CO₂ during the extrusion step with a proportion by mass of supercritical CO2 of between 25% and 1000% of the composition followed by degassing of the CO₂ and recovery of powder.

9. The use of a composition as claimed in claim 1, for the manufacture of electrodes with or without solvent.

10. An electrode obtained according to the use of claim 9.

11. A battery comprising at least one electrode as claimed in claim 10.
